(19) United States
(12) Patent Application Publication
(10) Pub. No.: US 2010/0101278 A1
(43) Pub. Date: Apr. 29, 2010

(54) END-FIRED FURNACE FOR GLASS TO BE FIBERIZED

(75) Inventor: Didier Jacques, Fontenay Sous Bois (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: SAINT-GOBAIN RECHERCHE, Aubervilliers (FR)

(21) Appl. No.: 12/519,533

(22) PCT Filed: Dec. 13, 2007
(86) PCT No.: PCT/FR07/52509

§ 371 Date: Aug. 17, 2009

(30) Foreign Application Priority Data
Dec. 18, 2006 (FR) 0655595

(51) Int. Cl. C03B 3/00; C03C 6/00; C03B 5/00

(52) U.S. Cl. 65/474; 65/540; 65/134.1

(57) ABSTRACT

The invention relates to an installation and a method of producing a glass having a low boron content, containing alumina or zirconia, the melting of the batch materials being carried out in an end-fired furnace equipped with regenerators, most of the fossil energy being introduced by the U-flame, the oxidant and fuel for which are introduced at the upstream face of said furnace, the oxidant being air or oxygen-enriched air. The melting compartment may be followed by a unit for fiberizing the glass. The invention makes it possible to produce fibers with an excellent combustion efficiency and high productivity.

The invention relates to an installation for melting a glass composition, especially one intended to be converted into fibers.

Glass fibers essentially have two types of application: reinforcement of composites and thermal insulation.

Glass compositions intended for reinforcing composites (with a thermosetting or thermoplastic organic matrix or an inorganic matrix, for example of the cement or concrete type) are generally relatively easy to melt in conventional furnaces of the type having side burners. The same does not apply in the case of certain alumina-rich compositions intended for insulation.

Some high-performance fibers (especially those having better mechanical strength and better corrosion resistance) must contain large amounts of an intermediate chemical element (this is the term used by those skilled in the art to denote an element having an intermediate role between network former and network modifier) such as alumina (Al₂O₃) or zirconia (ZrO₂). These elements also give improved fire resistance. The addition of these elements results in compositions that are more difficult to melt than conventional glass, such as soda-lime-silica glass. It is not always possible to use reputedly effective fluxes of the alkali metal oxide type since they adversely affect the corrosion resistance and the electrical resistance essential in certain applications. Boron oxide (B₂O₃) is often used as substitution flux for fiberizable glass compositions and its use has already been proposed for melting compositions having a high alumina content in side-fired furnaces.

It has already been proposed for more effective melting of a glass-forming composition (hereafter termed “batch”) containing no boron to add roof-mounted burners in a side-fired furnace and to supply all the burners with oxygen so as to be able to reach the necessary temperatures. The use of oxygen as oxidant also allows very high combustion efficiencies to be reached. However, oxygen is an expensive oxidant.

End-fired furnaces (horseshoe-fired furnaces) are usually employed for melting conventional glass of the soda-lime-silica type, more particularly for hollow ware. Hollow ware applications have less of a need for high glass quality, especially as regards the content of refining bubbles, in comparison with flat glass applications. An end-fired furnace is very suitable for hollow wear applications despite its relatively low flexibility. This is because an end-fired furnace has a flame essentially starting from the upstream face of the furnace and returning thereto after having described a U-shaped loop, and it is not really possible to change its operation. However, an end-fired furnace is of simple design, uses few burners and provides an exceptionally high combustion efficiency. Conversely, a side-fired furnace requires many more burners, which are tricky to regulate.

The Applicant has found that the use of an end-fired furnace does not necessarily lead to fiberizable glass since, in certain cases, the formation of parasitic phases makes the final glass completely unsuitable for being fiberized. It turns out that the presence of boron is without doubt the origin of this problem.

It has now been found that an end-fired furnace is very suitable for melting boron-free fiberizable batches containing alumina and/or zirconia. This is because it has been discovered that an end-fired furnace offers an ideal temperature profile for melting batches containing alumina and/or zirconia but no boron, and to do so with a small number of burners. By having a small number of burners, it is much easier to regulate a furnace. Very high combustion efficiencies, greater than 70% and even reaching 80%, may be obtained, while still being able to use air as oxidant. An end-fired furnace provides the necessary high temperature right from the charging zone. The invention therefore makes it possible to dispense with the use of boron oxide—an expensive flux. In addition, it has been observed that the absence of boron is reflected in less foam forming on the surface of the glass, thereby correspondingly improving the heat exchange between the flame and the molten bath.

The term “burner” is understood to mean the assembly comprising, in a juxtaposed manner, the fuel injector or injectors and the oxidant feed line or lines, contributing to the formation of a flame.

Document EP 805 123 has proposed the use of an oxy-combustion furnace (using pure oxygen as oxidant) with staged combustion for melting batch materials, especially in an end-fired furnace (see its FIG. 3). All possible applications of the glass, including in particular fiberizing, are provided. The main objective here is to reduce the wear of the refractories constituting the walls of the furnace. However, pure oxygen is an expensive oxidant and those skilled in the art seek to use air. Yet it is unthinkable to carry out staged combustion, as proposed by EP 805 123, with air since the flow rates of air to be supplied along the sides would require the construction of excessively long and excessively expensive piping.

Moreover, staged combustion goes counter to obtaining a high combustion efficiency. This is because heat transfer is all the more effective the higher the temperature. By staging the combustion, relatively low temperatures are obtained and the heat transfer is correspondingly reduced, leading to stones (faults due to imperfect melting of raw batch materials) in the final glass.

It has now been discovered that if most of the fossil energy is provided by the upstream face of an end-fired furnace, the final glass contains none of these undesirable defects. The invention makes it possible in particular to melt glass having a high content of Al₂O₃ and/or ZrO₂, with very high combustion efficiencies, generally greater than 70% and ranging in general from 70 to 80%.

The terms “upstream” and “downstream” are to be interpreted according to the directional flow of the molten material. A furnace generally has four sidewalls, the upstream face being that located furthermost upstream, on the opposite side from the downstream face located in the output zone for the molten material.

Thus, the invention relates in the first place to a method of producing a glass (by melting it) comprising less than 2% boron oxide (B₂O₃ base) by weight and containing alumina or zirconia (and therefore, when required, alumina and zirconia) in an amount such that the sum of the mass of alumina and the mass of zirconia is at least 8% by weight, the melting of the batch materials being carried out in an end-fired furnace equipped with regenerators, at least 80% of the fossil energy being introduced by the U-flame (horseshoe flame), the fuel and oxidant for which are introduced at the upstream face of said furnace, the oxidant being air or oxygen-enriched air, said oxidant containing at most 30% oxygen by volume. Preferably, 100% of the fossil energy is introduced by the U-flame, the oxidant and fuel for which are introduced at the upstream face of said furnace.

The batch materials may be introduced dry or wet via the upstream face or in an upstream zone of the sidewalls of the furnace. They are introduced wet if a risk of fly-off is of concern. Preferably, the batch materials are charged in the upstream zone of the sidewalls of the furnace via recesses in said sidewalls so as to limit fly-off of the pulverulent batch materials. These recesses are generally located in the first (upstream) third of the sidewalls. The batch materials are therefore generally introduced in powder form at the lateral recesses. If they are introduced dry, it is preferably done by means of screw chargers.

The invention also relates to an installation for manufacturing mineral fibers, which comprises an end-fired furnace for melting batch materials, followed by a fiberizing unit (in general for fiberizing glass). The end-fired furnace is equipped with at least one burner on the upstream face so as to produce a U-flame, said flame generating at least 80% of the fossil energy used to heat said furnace. A refining compartment may be placed between the furnace and the fiberizing unit, but this is not in general necessary since it has now been discovered that the fiberizing application is very tolerant of the presence of bubbles in the glass. Using the method according to the invention, the glass obtained may contain 100 to 6000 bubbles (of diameter less than 50 μm) per liter, this being very suitable for the fiberizing application. A simple feeder therefore generally connects the end-fired furnace to the fiberizing unit. The fiberizing unit will not be described in further detail in the present application in so far as this type of unit corresponds to those described in the literature and well known to those skilled in the art. The fibers intended here are more particularly those formed through orifices using for example processes in which the fiberizing takes place beneath a bushing or by internal centrifugation in a fiberizing spinner (see a general description of these processes in WO 01-61088 or EP 0 189 534). Thus, the invention also relates to a method of producing glass fibers comprising the method of producing a glass in an end-fired furnace followed by the conversion of said glass into fiber.

The oxidant used to operate the end-fired furnace is air or air enriched with pure oxygen, pure oxygen providing at most 40% of the total oxygen in the oxidant stream, which amounts to an oxidant containing at most 30% oxygen by volume. This oxidant has a temperature of at least 1250° C. and preferably at least 1350° C. Such a temperature is reached thanks to the use of regenerators. The oxidant is in fact heated by a regenerator before being introduced into the furnace.

Regenerators are well known to those skilled in the art. They are placed behind the upstream face of the furnace and consist of refractory bricks (which includes refractory ceramic bricks) placed in two separate compartments operating one after the other. The flame is sent from one half of the upstream face, then sweeps through the atmosphere of the furnace describing a horseshoe loop before returning to the other half of the upstream face. The flue gases are recovered via an orifice in this other half of the upstream face and the heat of said flue gases heats the refractory bricks placed in one of the regenerators behind the upstream face. When the refractory bricks are fully heated, the operation of the furnace is reversed, by making the flame leave from the other half of the furnace and recovering its flue gases via the other regenerator placed behind the other half of the furnace. The hot regenerator serves to heat up the air or oxygen-enriched air used as oxidant for the flame. The fuel (for example liquid fuel oil or combustible gas of the methane, propane or butane type) is introduced separately from the oxidant, but close to the point where the oxidant is introduced. In all cases, the fuel and the oxidant are introduced via the same half of the upstream face. The furnace may therefore be operated in one way until a temperature of at least 1250° C. is obtained in the regenerator recovering the flue gases, and then in the opposite way of operating the furnace. The temperature that can be tolerated in the regenerator depends of course on the choice of materials used. By using certain ceramics, it is even possible to achieve temperatures above 1450° C., and even around 1500° C. Moreover, it has been found that there are no deposits in the regenerators coming from the flue gases. The low boron oxide content (and, where appropriate, the low alkali metal oxide content) of the batch materials used seems to be the reason for this absence.

In addition to the furnace being mainly supplied with fossil energy via the upstream face, it is generally equipped with electric boost heating comprising in general from 0 to 50% of the total energy used in the furnace. Thus, generally 0 to 50%, and more generally 5 to 30%, of the total energy is of electrical origin (i.e. not fossil energy). The aim is in general to use as far as possible fossil energy, provided that the temperature that the furnace roof can withstand is not exceeded. The situation is therefore one in which a maximum level of fossil energy, dependent on the resistance of the roof refractories, is used and the boost energy needed is supplied electrically, generally via electrodes embedded in the molten bath. The electric boost also makes it possible to increase the output of the furnace.

The furnace may be equipped with a dam (made of refractory) immersed in the molten glass and placed in the downstream half or in the last (downstream) third of the furnace. The function of this dam is to promote convection currents within the molten glass bath. These movements constitute an agitation which increases the residence time, thereby resulting in a reduction in the stone content. On average, the glass may for example make tens of circulations before leaving the furnace via the flow outlet downstream. It is also possible to provide a transverse row of bubblers placed upstream of the dam, generally just in front of the dam, so as to promote convection. The function of these bubblers is also to expel foam, so as to improve heat transfer from the flame to the glass.

The glass covered by the present invention generally comprises at least 35% by weight, and generally at most 70% by weight, of silica. This glass generally contains less than 2% by weight, or even less than 1% by weight, of boron oxide (B₂O₃). In particular, E-glass containing little or no boron is very suitable. Boron oxide (B₂O₃ base) may nevertheless be optionally present in the final glass in an amount of less than 1 ppm by weight. The glass may even include a small amount of alkali metal oxide, especially less than 1% by weight, or even contain none at all. However, the glass preferably contains sufficient flux of the alkali metal oxide (R₂O with R=Na, Li or K) and alkaline-earth metal oxide (such as MgO, CaO, BaO, SrO) type (i.e. the sum of the mass of alkali metal oxides and the mass of alkaline-earth metal oxides) for its liquidus temperature to be below 1250° C., and preferably even below 1200° C. Thus, in the glass used according to the invention, the sum of the mass of alkali metal oxides and the mass of alkaline-earth metal oxides is generally greater than 20% by weight but less than 40% by weight.

The glass contains alumina (Al₂O₃) or zirconia (ZrO₂) (which means that it may contain alumina and zirconia) so that the sum of the percentages by weight of Al₂O₃ and ZrO₂ is at least 8% by weight, generally at least 10% by weight and even at least 12% by weight. However, said sum is generally less than 25% by weight. In particular, the glass may contain no zirconia, in which case the glass then contains at least 10% alumina by weight, but generally less than 25% alumina. The invention is more particularly suitable for compositions undergoing eutectic melting or essentially eutectic melting, which means that at least 95% by weight of the batch material undergoes eutectic melting.

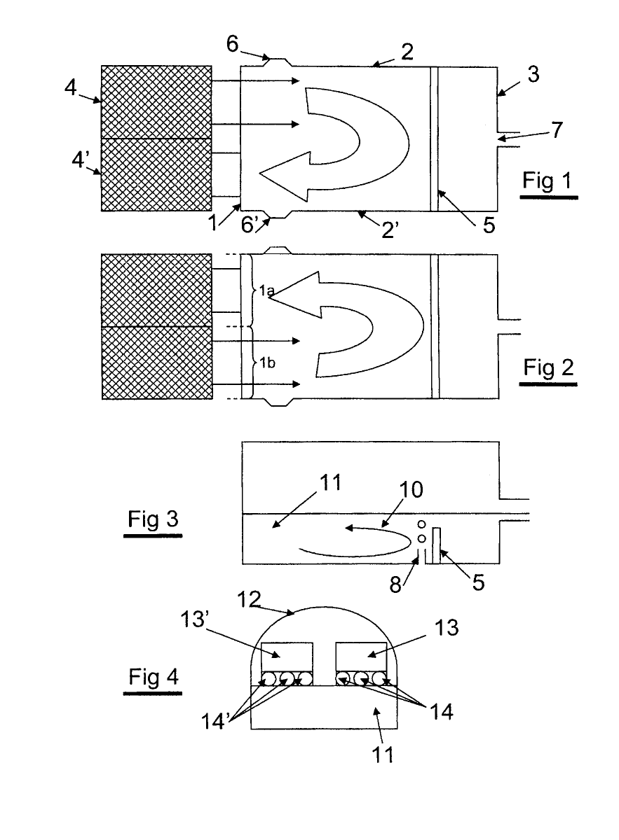

FIG. 1 shows an end-fired furnace that can be used within the context of the present invention, seen from above. This furnace comprises an upstream face 1, two side faces 2 and 2′ and a downstream face 3. It is provided with two juxtaposed identical regenerators 4 and 4′ both placed behind the upstream face. Each regenerator is placed behind one half of the upstream face. Recesses 6 and 6′ are provided in the sidewalls 2 and 2′ for introducing batch materials. These recesses are placed in the first (upstream) third of the sidewalls. A dam 5 submerged in the molten bath is provided in the downstream half of the furnace. In the case shown in FIG. 1, the flame emanates from one half 1a of the upstream face. It forms a horseshoe loop in the atmosphere of the furnace before turning back toward the other half 1b of the upstream face. The flue gases therefore pass through the regenerator 4′ placed behind the other half 1b of the upstream face. When the refractory bricks in the regenerator 4′ are hot enough, the operation of the furnace is reversed, as shown in FIG. 2. In this case, the flame emanates from the half 1b of the upstream face and the flue gas heat is recovered in the other regenerator 4. The oxidant for the flame is heated air that has passed through the regenerator 4′. The final glass is discharged through the orifice 7 provided in the downstream face 3 of the furnace. This glass then feeds a fiberizing unit.

FIG. 3 shows the furnace seen side-on through a sidewall. The dam 5 and the bubblers 8 may be distinguished, the latter generating bubbles, dispelling the foam on the surface of the glass and promoting heat exchange between the flame and the molten bath 11. Convection currents 10 are created within the molten bath 11.

FIG. 4 shows the furnace seen side-on through the downstream wall 3. Above the molten bath 11 and below the roof 12 of the furnace may be seen the two systems for generating the U-flame, said systems operating one after the other. Each flame generation system comprises an air intake 13 and 13′ and fuel injectors 14 and 14′.

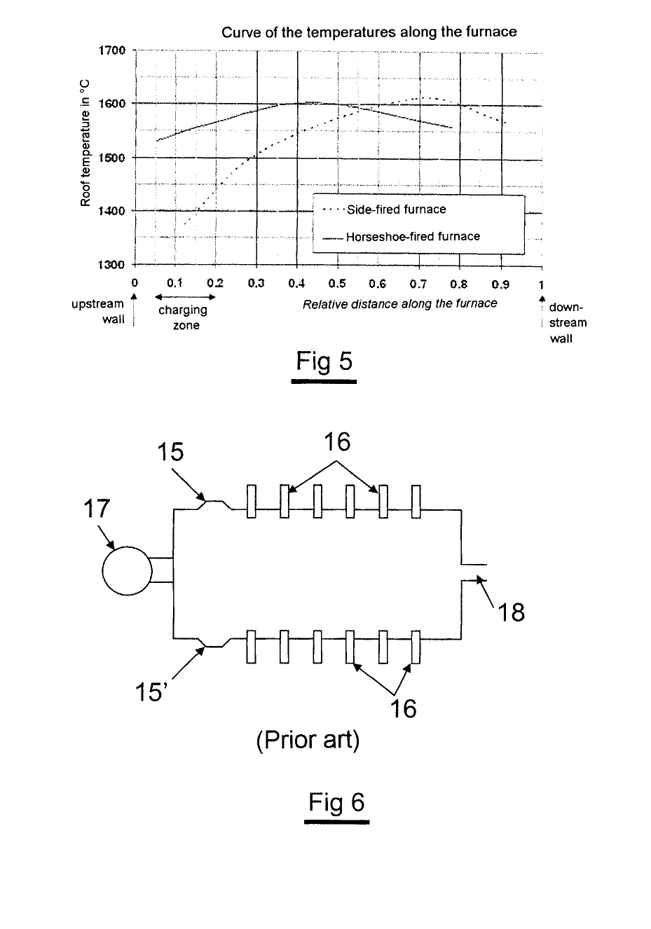

FIG. 5 compares the temperature curves along the furnace (the variation in temperature in the flow direction of the glass) in the case of the end-fired furnace according to the invention and in the case of a conventional side-fired furnace, having the same area and heating power. It may be seen that the end-fired furnace provides a higher upstream-most temperature, this being very conducive to melting glass rich in Al₂O₃ and/or ZrO₂. The side-fired furnace does not rise in temperature as quickly, which leads to stones in the case of the batch materials envisioned within the context of the present invention if the output becomes high. FIG. 6 shows this conventional side-fired furnace of the prior art, seen from above. In the case of this furnace, the batch materials are also introduced via recesses 15 and 15′ located upstream in the sidewalls. Many side-mounted burners 16 are provided in the sidewalls. The flue gas heat is recovered by the recuperator 17. The glass is recovered via the outlet 18. It will be recalled that a recuperator operates on the model of a heat exchanger, the flue gases passing through a channel, which heats up the air passing through another channel and feeding the side-mounted burners. In the case of regenerators (used within the context of the invention), there is only a single channel, the combustion gases heating the refractory components contained in the regenerator. The process is then reversed, fresh air then flowing through the regenerator so as to be heated up and supplying the burner with a stream of air. This type of operation means that the regenerators generally operate in pairs. It would be conceivable to produce a side-fired furnace equipped with regenerators, so as to increase the combustion efficiency and bring it close to that of the end-fired furnace. However, each burner would have to have its air penetration window, which is extremely expensive. To achieve the upstream temperatures observed in the case of the end-fired furnace, it would also be necessary to place side burners upstream of the charging recesses. Even assuming that the thermal performance (temperature profile and combustion efficiency) of the end-fired furnace is reached, the fact remains that as many penetration windows as there are burners are needed. This incurs considerable cost, given the number of burners involved. No side-fired furnace can therefore achieve, for the same cost, the performance of an end-fired furnace for the compositions envisioned. This result is not obvious to a person skilled in the art.

1. A method of producing a glass comprising less than 2% boron oxide by weight and containing alumina or zirconia in an amount such that the sum of the mass of alumina and the mass of zirconia is at least 8% by weight, wherein the melting of the batch materials is carried out in an end-fired furnace equipped with regenerators, at least 80% of the fossil energy being introduced by the U-flame, the fuel and oxidant for which are introduced at the upstream face of said furnace, the oxidant being air or oxygen enriched air, said oxidant containing at most 30% oxygen by volume.

2. The method as claimed in claim 1, wherein the glass contains sufficient flux of the alkali metal oxide or alkaline earth metal oxide type for its liquidus temperature to be below 1250° C.

3. The method as claimed in claim 2, wherein the glass contains sufficient flux of the alkali metal oxide or alkaline earth metal oxide type for its liquidus temperature to be below 1200° C.

4. The method as claimed in claim 1, wherein the sum of the mass of alkali metal oxides and the mass of the alkaline earth metal oxides is greater than 20% by weight.

5. The method as claimed in claim 1, wherein the sum of the mass of alkali metal oxides and the mass of the alkaline earth metal oxides is less than 40% by weight.

6. The method as claimed in claim 1, wherein 100% of the fossil energy is introduced by the U-flame, the oxidant and fuel for which are introduced at the upstream face of said furnace.

7. The method as claimed in claim 1, wherein the oxidant is air.

8. The method as claimed in claim 1, wherein 0 to 50% of the total energy is of electric origin.

9. The method as claimed in claim 8, wherein 5 to 30% of the total energy is of electric origin.

10. The method as claimed in claim 1, wherein the glass contains less than 1% of boron oxide.

11. The method as claimed in claim 1 wherein the glass contains alumina or zirconia in an amount such that the sum of the mass of alumina and zirconia is at least 10% by weight.

12. The method as claimed in claim 11, wherein the glass contains alumina or zirconium in an amount such that the sum of the mass of alumina and zirconia is at least 12% by weight.

13. A method of producing glass fibers, which comprises the method of preparing a glass as claimed in claim 1, followed by the conversion of said glass into fiber.

14. The method as claimed in the claim 13, wherein, for the conversion of said glass into fiber, the fibers pass through orifices.

15. The method as claimed in claim 1, wherein the oxidant is introduced into the furnace at a temperature of at least 1250° C.

16. The method as claimed in claim 15, wherein the oxidant is heated by a regenerator before being introduced into the furnace.

17. An installation for manufacturing mineral fibers, which comprises an end-fired furnace for melting batch materials, followed by a fiberizing unit, wherein the furnace is equipped with regenerators and means for introducing air or oxygen enriched air at the upstream face of the furnace, and in that the fiberizing unit forms the fibers through orifices.

18. The installation as claimed in claim 17, wherein the furnace is equipped with recesses placed in the first upstream third of the sidewalls, for charging the batch materials.

19. The installation as claimed in claim 17, wherein the furnace is equipped with a submerged dam placed in the downstream half of the furnace.

20. The installation as claimed in claim 19, wherein at least one transverse row of bubblers is placed upstream of the dam.

21. The installation as claimed in claim 17, wherein the furnace is provided with electrodes immersed in the molten bath.
